(19) United States
(12) Patent Application Publication
(10) Pub. No.: US 2008/0216041 A1
(43) Pub. Date: Sep. 4, 2008

(54) Integrated circuit simulation method considering stress effects

(75) Inventors: Quan Wangxiao, Gyeonggi-do (KR); Shigenobu Maeda, Gyeonggi-do (KR)

Correspondence Address: MYERS BIGEL SIBLEY & SAJOVEC, PO BOX 37428, RALEIGH, NC, 27627, US

(73) Assignee: Samsung Electronics Co., Ltd.

(21) Appl. No.: 12/019,841

(22) Filed: Jan. 25, 2008

(30) Foreign Application Priority Data
Mar. 2, 2007 (KR) 2007-21169

(51) Int. Cl. G06F 17/50

(52) U.S. Cl. 716/10; 716/14

(57) ABSTRACT

Provided is an integrated circuit (IC) simulation method which can predict the operation and performance of an IC considering stress effects that affect the characteristics of unit devices included in the IC. The method includes drawing out a first net list of unit devices included in a designed IC; preparing a layout of the designed IC; extracting a stress parameter from the layout of the designed IC; and drawing out a second net list of the first net list and the stress parameter.

### CROSS-REFERENCE TO RELATED PATENT APPLICATION

This application claims the benefit of Korean Patent Application No. 10-2007-0021169, filed on Mar. 2, 2007, in the Korean Intellectual Property Office, the disclosure of which is incorporated herein in its entirety by reference.

### FIELD OF THE INVENTION

The present invention relates to integrated circuit (IC) design, and more particularly, to an IC simulation method that can predict the operation and performance of the IC.

### BACKGROUND OF THE INVENTION

An integrated circuit (IC) may be designed to include a circuit having a very large number of transistors, for example, several hundreds of thousands of transistors. Thus, in order to efficiently and economically develop a new semiconductor IC, it is necessarily required to perform modeling, which involves conducting a simulation to estimate the characteristics of a designed IC (such as whether the IC operates properly or not and the performance and power consumption of the IC), feeding back the simulation result, and completing IC design based on the simulation result.

Generally, initial modeling used for IC design adopts a physical model based on physical phenomena. The physical model can be understood based on the physical properties of a semiconductor device, be easily changed due to a clear interaction between numerical expressions of the physical model, and provide a consistent and statistical analysis of extracted parameters. However, the physical model may include complicated numerical expressions, calculating the numeral expressions may take a long time, and the calculation results may turn out to be irrational in many cases. In particular, with the downscaling of semiconductor devices, the physical modeling may be utilized within only a very small range when the physical modeling includes a new, unestablished physical phenomenon. In order to overcome this drawback, an empirical model has been proposed. The empirical model can simply express a complicated physical relationship without the loss of accuracy and flexibly change numerical formulas to make it possible to explain even effects that are not shown in the model. Furthermore, it is possible to make an empirical model of a phenomenon that is not physically described but observed. However, an empirical model may include merely a feeble relationship between a parameter and a process, so that physically analyzing the empirical model may be difficult. Therefore, recent modeling used for IC design is showing a tendency to combine a physical model and an empirical model.

In general, a simulation used for IC design makes use of Simulation Program with Integrated Circuit Emphasis (SPICE) modeling. The completion of the SPICE modeling involves formulating a model formula for expressing the operation of a designed IC and extracting effective parameters from the model formula. With improvements in the structure and integration density of ICs, new physical phenomena, for example, a short channel effect, a narrow width effect, drain induced barrier lowering, mobility reduction, velocity saturation, channel length modulation, and sub-threshold conduction, have been found. Thus, a lot of modeling processes used for IC design have been proposed considering the above-described physical phenomena. However, it is necessary to conduct a vast amount of research on formulating a model that can make a precise analysis of individual practical physical phenomena, make a right forecast of the operation and performance of ICs, and facilitate the calculation of numeral expressions.

Typically, SPICE modeling needs many model parameters. The model parameters include parameters implying physical meanings, for example, parameters denoting the characteristics, dimensions, shapes, or arrangement of unit circuit devices, and simple parameters, which do not imply physical meanings and are used for a model formula formulated by the SPICE modeling. When simulating a designed IC, meaningful model parameters should be extracted from the model parameters. The extraction of the meaningful model parameters is completed after many measurements and repeated trial and error.

FIG. 1 is a flowchart illustrating a conventional IC simulation method 1.

Referring to FIG. 1, a first net list of unit devices included in a designed IC is drawn out (operation S10). The first net list is generally drawn out using a circuit diagram of the designed IC. For example, the length and width of a channel region of the unit device, the thickness of a gate insulating layer, and a variation of threshold voltage with the dopant concentration of the channel region may be put on the first net list. Thereafter, the layout of the designed IC is prepared (operation S20). A parasitic parameter is extracted from the layout of the designed IC (operation S30). The parasitic parameter includes, for example, a resistance element, a capacitance element, or an inductance element, which is caused by coupling between respective unit devices. The parasitic parameter may be predicted considering the shape of the layout, specifically, the dimensions, shapes, and arrangements of the respective unit devices and a distance between the unit devices. The parasitic parameter is an element that is not put on the first net list drawn out using the circuit diagram of the designed IC. Also, the parasitic parameter may be generated when the unit devices are actually formed and affect circuits. Thereafter, a second net list with respect to the first net list and the parasitic parameter is drawn out (operation S40). A final circuit simulation is conducted using the second net list (operation S50).

Since the above-described simulation method can be conducted considering electrical coupling effects between the respective unit devices, the performance of the designed IC can be embodied more efficiently. However, the above-described simulation method does not consider stress effects between the unit devices. The stress results in a piezoelectric effect, which is a major cause for changes in the electrical characteristics of the unit devices.

Japanese Patent Laid-open Publication No. 2004-86546 discloses a method of simulating an IC considering stress effects according to the dimension and shape of a transistor of the IC. However, the method does not consider stress effects caused by other adjacent transistors and involves a complicated process of drawing out a net list for modeling.

### SUMMARY OF THE INVENTION

The present invention provides an integrated circuit (IC) simulation method, which can predict the operation and performance of an IC considering stress effects that affect the characteristics of unit devices included in the IC.

According to an aspect of the present invention, there is provided an IC simulation method including: drawing out a first net list of unit devices included in a designed IC; preparing a layout of the designed IC; extracting a stress parameter from the layout of the designed IC; and drawing out a second net list of the first net list and the stress parameter.

The method according to the present invention may further include conducting a simulation using the second net list to inspect the operating characteristics of the designed IC.

The first net list may include the length and width of a channel of the unit device, the thickness of a gate insulating layer, and a variation of a threshold voltage with the dopant concentration of the channel.

The stress parameter may be extracted using technology computer aided design (TCAD) incorporating the widths of overlapping regions of adjacent unit devices and distances between the adjacent unit devices as raw data. The stress parameter may be induced in a plane stress state or in a 3-axis stress state.

The stress parameter may include at least one principal stress element. Also, the stress parameter may further include shear stress elements.

In some embodiments of the present invention, the method may further include extracting a parasitic parameter from the layout of the designed IC between the preparing of the layout of the designed IC and the drawing out of the second net list, and the second net list may further include the parasitic parameter. The parasitic parameter may include a resistance element, a capacitance element, an inductance element, or a combination thereof, which is induced by coupling between the unit devices.

The conducting of the simulation using the second net list to inspect the operating characteristics of the designed IC may be performed using a Simulation Program with Integrated Circuit Emphasis (SPICE) simulation.

According to another aspect of the present invention, there is provided an IC simulation method including: preparing a layout of a designed IC; extracting a stress parameter from the layout of the designed IC; and drawing out a third net list of unit devices included in the designed IC considering the stress parameter.

The method according to the present invention may further include conducting a simulation using the third net list to inspect the operating characteristic of the designed IC.

The third net list may include the length and width of a channel of the unit device, the thickness of a gate insulating layer, and a variation of a threshold voltage with the dopant concentration of the channel.

The stress parameter may be extracted using TCAD incorporating the widths of overlapping regions of adjacent unit devices and distances between the adjacent unit devices as raw data. Also, the stress parameter may be induced in a plane stress state or in a 3-axis stress state.

The stress parameter may include at least one principal stress element. Also, the stress parameter may further include shear stress elements.

In some embodiments of the present invention, the method may further include extracting a parasitic parameter from the layout of the designed IC between the preparing of the layout of the designed IC and the drawing out of the third net list, and the third net list may further include the parasitic parameter. The parasitic parameter may include a resistance element, a capacitance element, an inductance element, or a combination thereof, which is caused by coupling between the unit devices.

The conducting of the simulation using the third net list to inspect the operating characteristics of the designed IC may be performed using a SPICE simulation.

According to another aspect of the present invention, there is provided a computer-readable medium having embodied thereon a computer program for executing the method according to any one of claims 1 through 20.

### BRIEF DESCRIPTION OF THE DRAWINGS

The above and other features and advantages of the present invention will become more apparent by describing in detail exemplary embodiments thereof with reference to the attached drawings in which:

FIG. 1 is a flowchart illustrating a conventional integrated circuit (IC) simulation method;

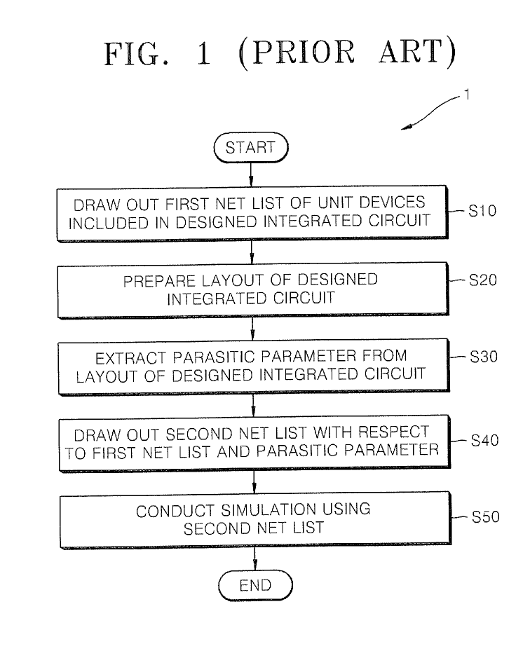

FIG. 2 is a conceptual plan view illustrating the layout of an IC to explain stress effects between unit devices formed in the IC;

FIG. 3 is a flowchart illustrating an IC simulation method considering stress effects according to an embodiment of the present invention; and

FIG. 4 is a flowchart illustrating an IC simulation method considering stress effects according to another embodiment of the present invention.

### DETAILED DESCRIPTION OF THE INVENTION

The present invention will now be described more fully hereinafter with reference to the accompanying drawings, in which exemplary embodiments of the invention are shown. This invention may, however, be embodied in different forms and should not be construed as limited to the embodiments set forth herein. Rather, these embodiments are provided so that this disclosure is thorough and complete and fully conveys the scope of the invention to one skilled in the art.

The latest semiconductor devices include many elements disposed in very small spaces, and the integration density of the semiconductor devices is on an accelerating trend. Therefore, the influences of variables that have been neglected before should be considered. For example, the variables include a coupling effect between adjacent unit devices or stress field effects caused by the formation and operation of each unit device. That is, a stress field may be generated at a base substrate or other unit device when a unit device is formed or operates due to applied power. The stress field results in a piezoelectric effect, which affects the electric characteristics of a semiconductor device, and the influence of the stress field increases as an interval between elements decreases.

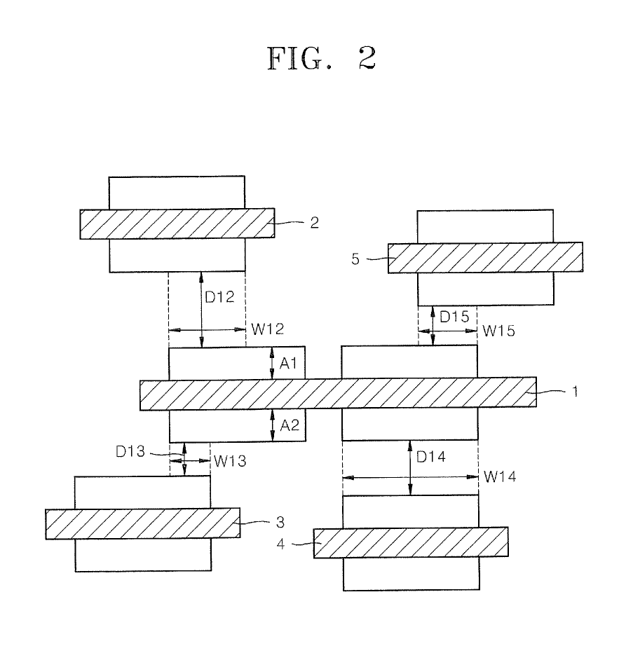

FIG. 2 is a conceptual plan view illustrating the layout of an integrated circuit (IC) to explain stress effects between unit devices formed in the IC. Referring to FIG. 2, transistors are illustrated as examples of unit devices formed in the IC. However, the transistors are exemplarily illustrated and the present invention is not limited thereto. A first transistor 1 is enclosed with second through fifth transistors 2, 3, 4, and 5. A stress field may be formed at the first transistor 1 according to the width A1 or A2 of an active region of the first transistor 1. Also, the second through fifth transistors 2, 3, 4, and 5 disposed adjacent to the first transistor 1 may generate a stress field at the first transistor 1. Specifically, a stress field caused by the second transistor 2 corresponds to a first width W₁₂ of a portion of an active region of the second transistor 2 that overlaps the active region of the first transistor 1 and a distance D₁₂ between the active regions of the first and second transistors 1 and 2. A stress field caused by the third transistor 3 corresponds to a second width W₁₃ of a portion of an active region of the third transistor 3 that overlaps the active region of the first transistor 1 and a distance D₁₃ between the active regions of the first and third transistors 1 and 3. A stress field caused by the fourth transistor 4 corresponds to a third width W₁₄ of a portion of an active region of the fourth transistor 4 that overlaps the active region of the first transistor 1 and a distance D₁₄ between the active regions of the first and fourth transistors 1 and 4. A stress field caused by the fifth transistor 5 corresponds to a fourth width W₁₅ of a portion of an active region of the fifth transistor 5 that overlaps the active region of the first transistor 1 and a distance D₁₅ between the active regions of the first and fifth transistors 1 and 5.

A piezoelectric effect caused by the stress field is expressed as in the following equations. Here, it is assumed that an IC including a unit device, such as a transistor, is a cubic material to facilitate the execution of a simulation.

Initially, when an electric field is applied to the cubic material, a relationship between the internal resistance of the cubic material and a current supplied to the cubic material can be expressed in Equation 1 (a matrix):

$$( \begin{matrix}{E}_{1} \\ {E}_{2} \\ {E}_{3}\end{matrix} ) = ( \begin{matrix}{ρ}_{1} & {ρ}_{6} & {ρ}_{5} \\ {ρ}_{6} & {ρ}_{2} & {ρ}_{4} \\ {ρ}_{5} & {ρ}_{4} & {ρ}_{3}\end{matrix} ) ( \begin{matrix}{i}_{1} \\ {i}_{2} \\ {i}_{3}\end{matrix} ) , \qquad ( 1 )$$

wherein reference character E denotes an electric field, ρ denotes the resistivity of the cubic material, and i denotes the current supplied to the cubic material. Subscripts 1, 2, and 3 denote the directions of an x-axis, a y-axis, and a z-axis, respectively. Each of subscripts 4, 5, and 6 of the resistivity ρ of the cubic material denotes the resistivity of the cubic material when a direction of the application of the electric field differs from a direction of the current. Since subscripts in the following equations are the same as in Equation 1, a description thereof will be omitted.

A piezoelectric effect refers to the generation of a stress field or a strain field in an object due to an electric field or a change in the resistivity of an object due to a stress field or a strain field. Therefore, the change in the resistivity of the object due to the stress field can be expressed in the following Equation 2:

$$( \begin{matrix}{ρ}_{1} \\ {ρ}_{2} \\ {ρ}_{3} \\ {ρ}_{4} \\ {ρ}_{5} \\ {ρ}_{6}\end{matrix} ) = ( \begin{matrix}{ρ}_{0} \\ {ρ}_{0} \\ {ρ}_{0} \\ 0 \\ 0 \\ 0\end{matrix} ) + ( \begin{matrix}Δ {ρ}_{1} \\ Δ {ρ}_{2} \\ Δ {ρ}_{3} \\ Δ {ρ}_{4} \\ Δ {ρ}_{5} \\ Δ {ρ}_{6}\end{matrix} ) \qquad ( 2 )$$

wherein reference character ρ₀ denotes the resistivity of a material when there is no stress field. Δρᵢ denotes a variation of the resistivity of the material that varies with the foregoing stress field. Here, ρ₄, ρ₅, and ρ₆ can be neglected to simplify a simulation.

Meanwhile, a relationship between the stress field and the strain field can be expressed in Equation 3 in the case of cubic:

$$( \begin{matrix}{ξ}_{1} \\ {ξ}_{2} \\ {ξ}_{3} \\ {ξ}_{4} \\ {ξ}_{5} \\ {ξ}_{6}\end{matrix} ) = ( \begin{matrix}{π}_{11} & {π}_{12} & {π}_{12} & 0 & 0 & 0 \\ {π}_{12} & {π}_{11} & {π}_{12} & 0 & 0 & 0 \\ {π}_{12} & {π}_{12} & {π}_{11} & 0 & 0 & 0 \\ 0 & 0 & 0 & {π}_{44} & 0 & 0 \\ 0 & 0 & 0 & 0 & {π}_{44} & 0 \\ 0 & 0 & 0 & 0 & 0 & {π}_{44}\end{matrix} ) \cdot ( \begin{matrix}{σ}_{1} \\ {σ}_{2} \\ {σ}_{3} \\ {σ}_{4} \\ {σ}_{5} \\ {σ}_{6}\end{matrix} ) , \qquad ( 3 )$$

wherein σᵢ denotes stress and ξᵢ denotes strain. Also, σ₁, σ₂, and σ₃ denote principal stresses, and σ₄, σ₅, and σ₆ denote shear stresses. π₁₁, π₂₂, π₃₃ denote x-axial, y-axial, and z-axial Young's modulus, respectively, and π₁₂ and π₄₄ denote shear modulus.

As described above, strain may be correlated to stress due to a piezoelectric effect, and when neglecting the influence of ρ₄, ρ₅, and ρ₆, the following Equation 4 can be obtained:

ρ/ρ₀=σ₁π₁₁+(σ₂+σ₃)π₁₂ (4).

Also, since ρ is proportional to a reciprocal of the mobility μ, ρ/ρ₀ is proportional to a reciprocal of μ/μ₀ (i.e., ρ/ρ₀∝μ₀/μ).

σ₃, which is typically expressed as σ_{zz}, denotes stress applied in a vertical direction to a unit device (e.g., a transistor) formed in an IC, that is, stress applied in the height direction of a gate electrode of the transistor. σ₃ is negligible in 130-nm-regime processes, but σ₃ should be considered in sub-90-nm-regime processes. Also, when an IC includes unit devices stacked in a vertical direction, it should be noted that the influence of σ₃ may be increased. Furthermore, shear stress σ₄, σ₅, and σ₆ is not considered in Equation 4 because the shear stress σ₄, σ₅, and σ₆ has no influence of the first-degree coefficient on the mobility. However, when unit devices are downscaled or more unit devices are formed in an IC, the influence of the shear stress σ₄, σ₅, and σ₆ can be considered.

Table 1 shows a variation in the mobility of electrons or holes according to the direction of a transistor when stress is applied to the transistor. In Table 1, an X-axial direction is a direction between a source and a drain (or a widthwise direction of a gate), a Y-axial direction, which is a lengthwise direction of the gate, is perpendicular to the X-axial direction, and a Z-axial direction, which is a height direction of the gate, is perpendicular to the Y-axial direction.

TABLE 1

| | | | Mobility | |
|---|---|---|---|---|
| Stress | | Direction | Electron | Hole |
| Tensile stress | Uniaxial stress | X | Increase | Decrease |
| | | Y | Increase | Increase |
| | | Z | Decrease | Increase |
| | Biaxial stress | X-Y | Increase* | Increase* |
| Compressive | Uniaxial stress | X | Decrease | Increase |
| stress | | Y | Decrease | Decrease |
| | | Z | Increase | Decrease |
| | Biaxial stress | X-Y | Increase* | Increase* |

*denotes a case where a long channel is used.

Simulation Program with Integrated Circuit Emphasis (SPICE) modeling may be performed using the above-described elements that generate a stress field, for example, the width A1 and A2 of the active region, the widths W₁₂, W₁₃, W₁₄, and W₁₅ of overlapping regions of the active regions, and distances D₁₃, D₁₄, and D₁₅ between the adjacent active regions as input parameters. In this case, however, SPICE modeling cannot be efficiently performed since too many parameters are input.

When reconsidering the foregoing elements, it can be known that all the foregoing elements may generate a stress field and thus, respective stress elements of the foregoing elements can be obtained. The stress elements can be combined and simplified. As an example, there is a method of simplifying the number of parameters using technology computer aided design (TCAD). Specifically, TCAD is performed so that the foregoing elements are converted into 2-dimensional or 3-dimensional stress elements that affect a point on the IC or a unit device. According to the above-described method, since the 2-dimensional or 3-dimensional stress elements include only two or three stress elements, subsequent SPICE modeling can be simply conducted. Also, TCAD and SPICE modeling can be conducted by increasing the area of the entire IC or expanding the entire unit devices included in the IC if required.

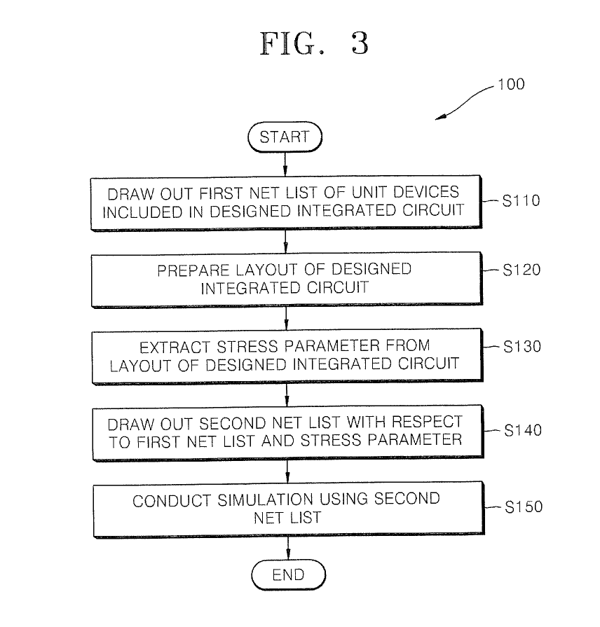

FIG. 3 is a flowchart illustrating an IC simulation method 100 considering stress effects according to an embodiment of the present invention.

Initially, a first net list of unit devices included in a designed IC is drawn out (operation S110). For example, the length and width of a channel region of the unit device, the thickness of a gate insulating layer, and a variation of threshold voltage with the dopant concentration of the channel region may be put on the first net list. Thus, elements that affect the IC due to interaction between the unit devices included in the IC, for example, elements caused by coupling or stress, are not put on the first net list. For example, the operating characteristic of the unit device, such as a current-voltage (IV) curve, is actually measured and a SPICE simulation is conducted so that optimum values with which the measurement result can be equal to the simulation result can be put on the first net list.

Thereafter, the layout of the designed IC is prepared (operation S120). In order to embody the designed IC (i.e., a circuit diagram) on a wafer, a layout including information on the dimensions, shapes, and arrangement of the respective unit devices is prepared. Thus, the influence of the dimensions, shapes, and arrangement of the respective unit devices on the characteristics of the IC, that is not shown in the circuit diagram, can be predicted using the layout.

Thus, a stress parameter is extracted from the layout of the designed IC (operation S130). As described above, the stress parameter can be extracted using TCAD incorporating the widths of overlapping regions of adjacent unit devices and distances between the adjacent unit devices as raw data.

Also, the layout can be typically expressed as a 2-dimensional plane, and a 3-dimensional IC can be shown using a plurality of layouts. A unit device can consider plane stress. Here, a “plane” is defined by one axis disposed in a direction between a source and a drain and the other axis disposed in a lengthwise direction of a gate. However, with the downscaling of the unit devices, stress applied in another direction, i.e., a height direction of the gate, should be considered. Therefore, the stress parameter may be induced in a plane stress state or in a 3-axis stress state.

As stated above, the stress parameter may include one or more principal stress elements (refer to Equation 4). Also, the stress parameter may further include shear stress elements if necessary. In general, when the stress parameter includes only principal stress elements, a time taken for subsequent SPICE modeling can be reduced. Also, when the stress parameter further includes shear stress elements, more accurate modeling results can be obtained. Since a detailed description of stress elements of the stress parameter is the same as described above in relation with Equations 1 through 4, it will be omitted here for brevity.

Thereafter, a second net list is drawn out considering both the first net list and the stress parameter (operation S140). The second net list can be drawn out by simply adding the stress parameter to the first net list. Also, the second net list can be drawn out considering physical or nonphysical interaction between the first net list and the elements of the stress parameter.

Thereafter, a simulation is conducted using the second net list to inspect the operating characteristics of the designed IC (operation S150). Operation S150 can be performed using, for example, a SPICE simulation. As a result of the simulation, the characteristics of the IC can be efficiently analyzed and estimated, and the simulation result can be fed back for the design of an IC or layout so that an IC having desired characteristics can be easily embodied.

Furthermore, an operation of extracting a parasitic parameter from the layout can be further performed between operation S120 in which the layout of the designed IC is prepared and operation S140 in which the second net list is drawn out. The extraction of the parasitic parameter may be performed before, after, or at the same time with operation S130 in which the stress parameter is extracted. The parasitic parameter may include, for example, a resistance element, a capacitance element, an inductance element, or a combination thereof, which is caused by coupling between respective unit devices. Also, the parasitic parameter may not be included in the stress element.

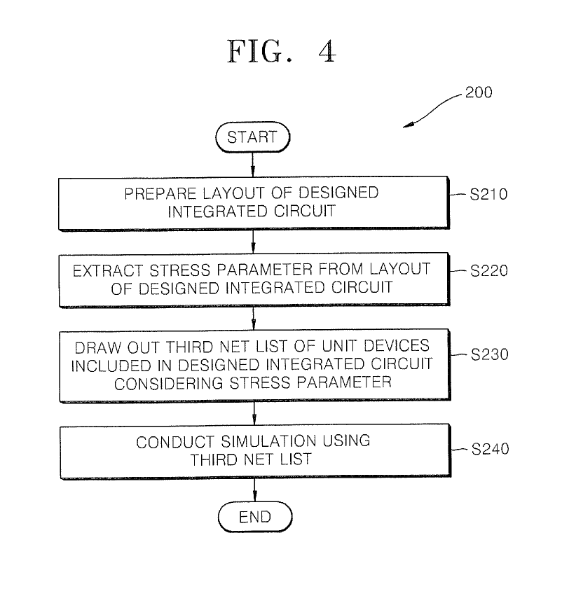

FIG. 4 is a flowchart illustrating an IC simulation method 200 considering stress effects according to another embodiment of the present invention. The same description as in the above-described IC simulation method 100 will be omitted for brevity.

Initially, the layout of a designed IC is prepared (operation S210). In order to embody the designed IC (i.e., a circuit diagram) on a wafer, the layout including information on the dimensions, shapes, and arrangement of respective unit devices is prepared. Thus, the influence of the dimensions, shapes, and arrangement of the respective unit devices on the characteristics of the IC, that are not shown in the circuit diagram, can be predicted using the layout.

Thus, a stress parameter is extracted from the layout of the designed IC (operation S220). As described above, the stress parameter can be extracted using TCAD incorporating the widths of overlapping regions of adjacent unit devices and distances between the adjacent unit devices as raw data. Also, a layout can be typically expressed as a 2-dimensional plane, and a 3-dimensional IC can be shown using a plurality of layouts. Furthermore, the stress parameter may include one or more principal stress elements. Also, the stress parameter may further include shear stress elements if necessary. Since a detailed description of stress elements of the stress parameter is the same as in the previous embodiment, it will be omitted here for brevity.

A third net list of the respective unit devices of the designed IC is drawn out considering the stress parameter (operation S230). For example, the length and width of a channel region of the unit device, the thickness of a gate insulating layer, and a variation of threshold voltage with the dopant concentration of the channel region may be put on the third net list. Thus, elements that affect the IC due to interaction between the unit devices included in the IC, for example, elements caused by coupling or stress, are not put on the third net list. Also, the third net list can be drawn out considering physical or nonphysical interaction between the elements of the stress parameter.

Thereafter, a simulation is conducted using the third net list to inspect the operating characteristics of the designed IC (operation S240). Operation S240 can be performed using, for example, a SPICE simulation.

Furthermore, an operation of extracting a parasitic parameter from the layout can be further performed between operation S210 in which the layout of the designed IC is prepared and operation S230 in which the third net list is drawn out. The extraction of the parasitic parameter may be performed before, after, or at the same with operation S220 in which the stress parameter is extracted. The parasitic parameter may include, for example, a resistance element, a capacitance element, an inductance element, or a combination thereof, which is caused by coupling between respective unit devices. Also, the parasitic parameter may not be included in the stress element.

As a result of the simulation, the characteristics of the IC can be efficiently analyzed and estimated, and the simulation result can be fed back for the design of an IC or layout so that an IC having desired characteristics can be easily embodied.

The IC simulation methods 100 and 200 considering stress effects according to the embodiments of the invention can also be embodied as computer readable programs or codes on a computer readable recording medium. The computer readable recording medium is any data storage device that can store programs or data which can be thereafter read by a computer system. Examples of the computer readable recording medium include read-only memory (ROM), random-access memory (RAM), CD-ROMs, digital versatile disc (DVD), magnetic tapes, hard disks, floppy disks, flash memory, optical data storage devices, and, and carrier waves (such as data transmission through the Internet). The computer readable recording medium can also be distributed over network coupled computer systems so that the computer readable code is stored and executed in a distributed fashion. Here, a program or code stored in a recording medium is expressed in a series of instructions used directly or indirectly within a device with a data processing capability, such as, computers. Thus, a term “computer” involves all devices with data processing capability in which a particular function is performed according to a program using a memory, input/output devices, and arithmetic logics.

As described above, the present invention provides an IC simulation method considering stress effects, which is more precise, efficient, and predictable in designing and embodying an IC than conventional methods. In particular, with an increase in the integration density of unit devices of the IC and the downscaling of the unit devices, the influence of interaction between the unit devices on the characteristics of the IC can be easily analyzed and estimated, so that the analysis and estimation results can be efficiently fed back for the design of the IC or layout. While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A method of generating an integrated circuit layout, comprising:
generating a first layout of an integrated circuit having a plurality of devices therein from a schematic netlist of the integrated circuit;
extracting at least one stress parameter associated with a first one of the plurality of devices, from the first layout; and
updating the schematic netlist of the integrated circuit to account for at least some parasitic effects of the at least one stress parameter on an operation of the first one of the plurality of devices.

2. The method of claim 1, wherein said updating step is followed by a step of generating a second layout of the integrated circuit from the updated schematic netlist of the integrated circuit.

3. The method of claim 2, wherein generating a second layout of the integrated circuit comprises generating a second layout of the integrated circuit that modifies a placement of the first one of the plurality of devices therein relative to a placement of the first one of the plurality of devices within the first layout.

4. The method of claim 1, wherein extracting at least one stress parameter comprises simulating electrical operation of the first layout of the integrated circuit.

5. A computer program product that generates an integrated circuit layout and comprises a computer-readable storage medium having computer-readable program code embodied in said medium, said computer-readable program code comprising:
computer-readable program code that generates a first layout of an integrated circuit having a plurality of devices therein from a schematic netlist of the integrated circuit;
computer-readable program code that extracts at least one stress parameter associated with a first one of the plurality of devices, from the first layout;
computer-readable program code that updates the schematic netlist of the integrated circuit to account for at least some parasitic effects of the at least one stress parameter on an operation of the first one of the plurality of devices; and
computer-readable program code that generates a second layout of the integrated circuit from the updated schematic netlist of the integrated circuit

6. An integrated circuit (IC) simulation method comprising:
drawing a first net list of unit devices included in a designed IC;
preparing a layout of the designed IC;
extracting a stress parameter from the layout of the designed IC; and
drawing a second net list with respect to the first net list and the stress parameter.

7. The method of claim 6, further comprising conducting a simulation using the second net list to inspect the operating characteristics of the designed IC.

8. The method of claim 6, wherein the first net list comprises the length and width of a channel of the unit device, the thickness of a gate insulating layer, and a variation of a threshold voltage with the dopant concentration of the channel.

9. The method of claim 6, wherein the stress parameter is extracted using technology computer aided design (TCAD) incorporating the widths of overlapping regions of adjacent unit devices and distances between the adjacent unit devices as raw data.

10. The method of claim 9, wherein the stress parameter is induced in a plane stress state or in a 3-axis stress state.

11. The method of claim 9, wherein the stress parameter comprises at least one principal stress element.

12. The method of claim 11, wherein the stress parameter further comprises shear stress elements.

13. The method of claim 6, further comprising extracting a parasitic parameter from the layout of the designed IC between the preparing of the layout of the designed IC and the drawing out of the second net list,
wherein the second net list further includes the parasitic parameter.

14. The method of claim 13, wherein the parasitic parameter comprises at least one of a resistance element, a capacitance element, an inductance element, and a combination thereof, which are induced by coupling between the unit devices.

15. The method of claim 7, wherein the conducting of the simulation using the second net list to inspect the operating characteristics of the designed IC is performed using a Simulation Program with Integrated Circuit Emphasis (SPICE) simulation.

16. An integrated circuit (IC) simulation method comprising:
preparing a layout of a designed IC;
extracting a stress parameter from the layout of the designed IC; and
drawing out a third net list of unit devices included in the designed IC considering the stress parameter.

17. The method of claim 16, further comprising conducting a simulation using the third net list to inspect the operating characteristic of the designed IC.

18. The method of claim 16, wherein the third net list comprises the length and width of a channel of the unit device, the thickness of a gate insulating layer, and a variation of a threshold voltage with the dopant concentration of the channel.

19. The method of claim 16, wherein the stress parameter is extracted using TCAD incorporating the widths of overlapping regions of adjacent unit devices and distances between the adjacent unit devices as raw data.

20. The method of claim 19, wherein the stress parameter is induced in a plane stress state or in a tri-axis stress state.

21. The method of claim 19, wherein the stress parameter comprises at least one principal stress element.

22. The method of claim 21, wherein the stress parameter further comprises shear stress elements.

23. The method of claim 16, further comprising extracting a parasitic parameter from the layout of the designed IC between the preparing of the layout of the designed IC and the drawing out of the third net list,
wherein the third net list further comprises the parasitic parameter.

24. The method of claim 23, wherein the parasitic parameter includes at least one of a resistance element, a capacitance element, an inductance element, and a combination thereof, which are caused by coupling between the unit devices.

25. The method of claim 17, wherein the conducting of the simulation using the third net list to inspect the operating characteristics of the designed IC is performed using a SPICE simulation.
